(19) United States
(12) Patent Application Publication
(10) Pub. No.: US 2008/0117953 A1
(43) Pub. Date: May 22, 2008

(54) Frequency offset estimation circuit of receiving device of wireless transmission system

(76) Inventors: Yu-Min Chuang, Hsinchu City (TW); Fu-Min Yeh, Taoyuan City (TW); Juinn-Horng Deng, Pingjhen City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/601,764

(22) Filed: Nov. 20, 2006

(51) Int. Cl. H04B 1/713; H04L 27/22; H04B 1/69

(52) U.S. Cl. 375/136; 375/130; 375/316; 375/E01.033

(57) ABSTRACT

The present invention is related to a frequency offset estimation circuit of receiving device of wireless transmission system, which includes a delay unit, a multiplier, an angle estimator, a compensation unit, and an arithmetic logic unit. The delay unit receives a preamble symbol of a baseband and delays the preamble symbol, the preamble symbol adjusts by a launcher of the wireless transmission system, and the launcher adjusts the preamble symbol in accordance with a cover sequence. The multiplier multiplies the preamble symbol and after delayed the preamble symbol by the delay unit for producing a first data. The angle estimator estimates the first data for an estimative value of phase shift. The compensation unit determines the estimative value of phase shift to compensate the estimative value of phase shift. The arithmetic logic unit produces a frequency deviation in accordance with after compensated the estimative value of phase shift by the compensation unit.

### BACKGROUND OF THE INVENTION

1. Field of the invention

The present invention relates to a frequency offset estimation circuit, and more particularly to a frequency offset estimation circuit of receiving device of wireless transmission system.

2. Description of the Related Art

The term “science and technology came from energize” which was a popular advertising word. Nowadays the objective of the technological development rapidly is to supply a convenient and comfortable environment for people's life. For example, the mobile phone brings more convenient in people's life, but its function only providing for communication would not satisfy a demand of today. Thus the manufacturer designs more new electronic product in order to provide a most convenient and most comfortable environment for people's life.

A preamble data was adjusted by a launcher of the wireless transmission system when the preamble data of the launcher of the wireless transmission system conveyed to a receiving device. The launcher adjusted the preamble data to improve the transmission efficacy of the wireless transmission system in accordance with a cover sequence. Wherein the preamble data was a preamble symbol, which is 24 of number of the identical symbol. A baseband included a header symbol and a payload symbol. The header symbol was a major parameter of efficient symbol such as a code rate and a data length. The efficient symbol was a data conveying from the launcher since between the launcher of the wireless transmission system and the receiving device had 7 different piconet which could select a transmission packet data, moreover, defining between each of symbol had different manner of frequency hopping to proceed data transmission within each of piconet. Wherein a first piconet and a second piconet needed 3 reference clocks, so that 3 symbol period could return to the same band; a third piconet to a seventh piconet needed one reference clock, that is to say, one symbol period could return to the same band.

A problem of an oscillator phase offset existed between the launcher of the wireless transmission system and the receiving device, so the receiving device set a frequency estimator for revising a problem of frequency offset, as shown in FIG. 1. A multiplier 222 multiplied the preamble symbol and after delayed the preamble symbol by a delay unit 221 and conveyed to an angle estimator 223 for estimating an estimative value of phase shift to obtain a frequency deviation. The receiving device revised a radio frequency in accordance with the frequency deviation. However, because the radio frequency included a preamble and the multiplier 222 multiplied the preamble symbol and a cover sequence, so this way caused the problem of frequency offset, then the receiving device received the error data.

Therefore the present invention proves a novel frequency offset estimation circuit of receiving device of wireless transmission system for the foregoing problem; it not only improves the problem of frequency offset but also increases accuracy of the frequency estimator and profit of time average.

### SUMMARY OF THE INVENTION

One object of the present invention is to provide a frequency offset estimation circuit of receiving device of wireless transmission system that a frequency offset is compensated by a cover sequence for getting a current frequency deviation.

Another object of the present invention is to provide a frequency offset estimation circuit of receiving device of wireless transmission system that an environmental noise affects an accumulator and an average unit for obtaining an exact frequency deviation.

The frequency offset estimation circuit of the receiving device of the wireless transmission system of the present invention comprises a delay unit, a multiplier, an angle estimator, a compensation unit, and an arithmetic logic unit. The delay unit receives a preamble symbol of a baseband and delayed the preamble symbol. The preamble symbol is adjusted by a launcher of the wireless transmission system. The launcher adjusts the preamble symbol in accordance with a cover sequence. The multiplier multiplies the preamble symbol and after delayed the preamble symbol by the delay unit for producing a first data. The angle estimator estimates the first data for an estimative value of phase shift. The compensation unit determines the estimative value of phase shift to compensate the estimative value of phase shift. The arithmetic logic unit produces a frequency deviation in accordance with after compensated the estimative value of phase shift by the compensation unit.

The frequency offset estimation circuit of the present invention further comprises an accumulator and an average unit. The accumulator accumulates after compensated a plurality of estimative value of phase shift by the compensation unit for producing a total. The average unit averages the total and the total is delivered to the arithmetic logic unit to gain the frequency deviation.

### BRIEF DESCRIPTION OF THE DRAWINGS

The present invention will become more fully understood from the detailed description given hereinbelow and the accompanying drawings, given by way of illustration only and thus not intended to be limitative of the present invention.

FIG. 1 shows a block diagram of frequency estimator of the prior art;

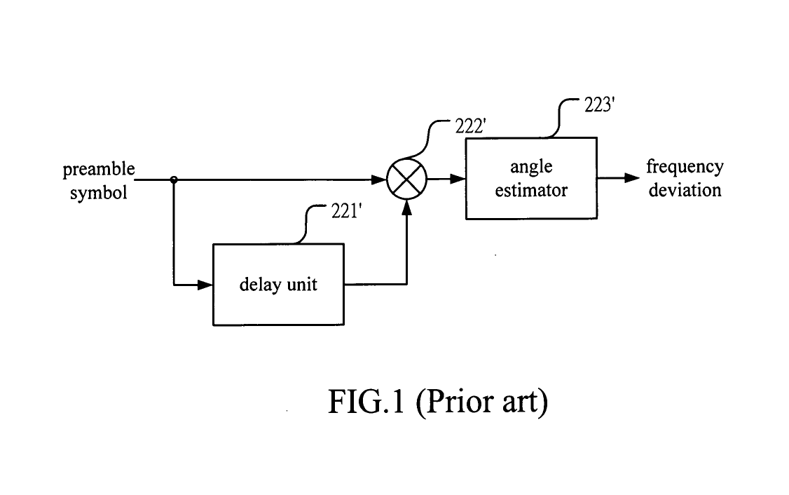

FIG. 2 shows a block diagram of the wireless transmission system used for the present invention;

FIG. 3 shows a block diagram in accordance with one preferred embodiment of the present invention;

FIG. 4 shows a block diagram in accordance with another preferred embodiment of the present invention.

### DETAILED DESCRIPTION OF THE PREFERRED EMBODIMENT

In order to make the examiner understanding the structure characteristic and efficiency of the present invention, providing an embodiment of the present invention and detailed description, the description as follows:

The present invention proceeds to estimate the frequency for the preamble symbol of the frequency estimator with the cover sequence of the receiving device of the wireless transmission system. Although the present invention uses a Multi-Band Orthogonal Frequency Division Multiplexing Ultra Wide Band (MB-OFDM) system for an embodiment of example, the present invention is not limited by the Multi-Band Orthogonal Frequency Division Multiplexing Ultra Wide Band system.

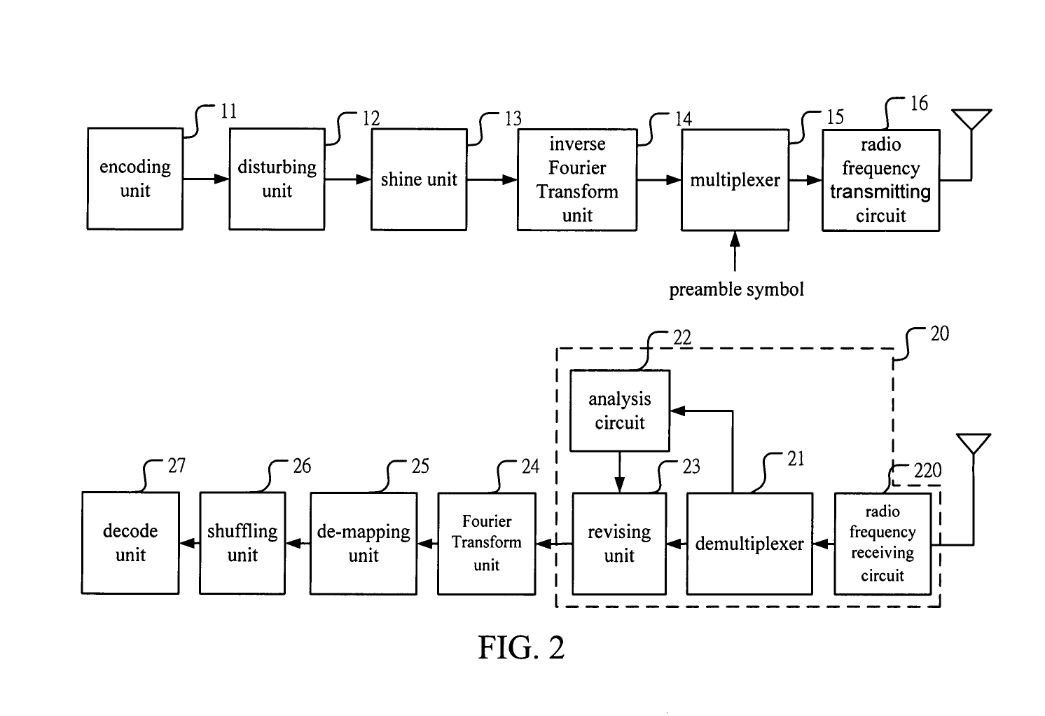

Referring to FIG. 2, it is a block chart of the transmission system used for this present invention. As drawn, the transmission system includes a sending device and a receiving device. The sending device comprises an encoding unit 11, a disturbing unit 12, a shine unit 13, an inverse Fourier Transform unit 14, a multiplexer 15, and a radio frequency transmitting circuit 16. The encoding unit 11 receives an input signal and encodes the input signal. The disturbing unit 12 disturbs the input signal encoded by the encoding unit 11. The shine unit 13 shines the signal disturbed by the disturbing unit 12. The inverse Fourier Transform unit 14 transfers the signal shined by the shine unit 13, the signal transfers from a signal of frequency domain to a signal of time domain. The multiplexer 15 receives the signal of time domain and a preamble symbol for producing a signal of Frequency-Hopping sequence to the radio frequency transmitting circuit 16, the radio frequency transmitting circuit 16 transfers the signal of Frequency-Hopping Sequence as a radio frequency and a Transmitting Antenna transmits the radio frequency.

The receiving device comprises a Frequency-Hopping analysis circuit 20, a Fourier Transform unit 24, a de-mapping unit 25, a shuffling unit 26, and a decode unit 27. A radio frequency receiving circuit 220 of the Frequency-Hopping analysis circuit 20 receives a radio frequency of launch device of wireless transmission system and downs the radio frequency for producing a baseband signal in accordance with a Frequency-Hopping sequence. A demultiplexer 21 receives the baseband signal and transmits the preamble symbol of the baseband signal to an analysis circuit 22 and transmits a payload of the baseband signal to a revising unit 23 respectively.

The analysis circuit 22 receives the preamble symbol and analyses the preamble symbol for getting a frequency deviation and transmits to the revising unit 23 to revises the payload of the baseband signal in accordance with the frequency deviation and transmits to the Fourier Transform unit 24. The Fourier Transform unit 24 transfers the signal as the signal of frequency domain transmitted from the revising unit 23. The de-mapping unit 25 encodes the signal of frequency domain transferred from the Fourier Transform unit 24 and transmits to the shuffling unit 26. The shuffling unit 26 recomposes the signal processed by the de-mapping unit 25, and then the signal processed by the shuffling unit 26 is decoded by the decode unit 27.

The present invention of the analysis circuit 22 further sets a frequency offset estimation circuit for compensating the frequency offset resulted by the cover sequence to get the frequency deviation. The following description is the frequency offset estimation circuit.

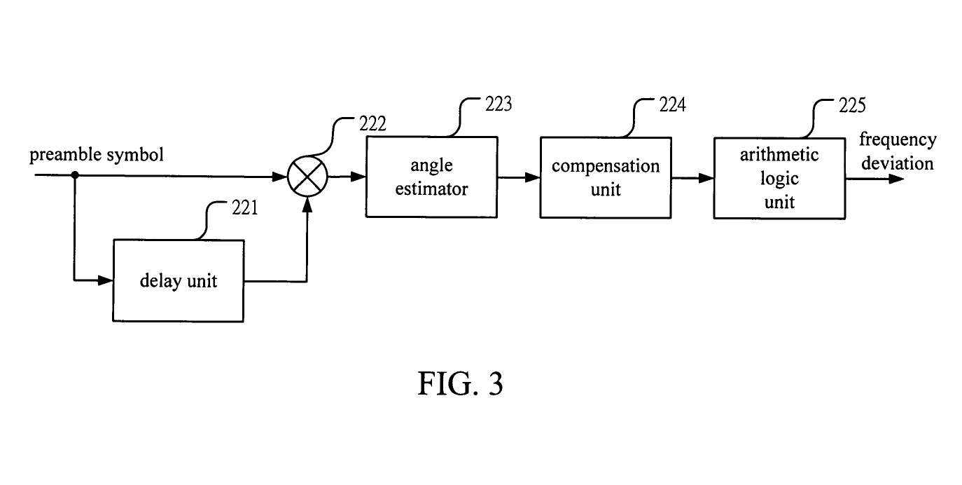

Referring to FIG. 3, it is a block diagram in accordance with one preferred embodiment of the present invention. As drawn, the frequency offset estimation circuit of the receiving device of the present invention comprises a delay unit 221, a multiplier 222, an angle estimator 223, a compensation unit 224, and an arithmetic logic unit 225. The frequency offset estimation circuit of the receiving device receives a preamble symbol of a baseband. The preamble symbol is adjusted by a launcher of the wireless transmission system. The launcher adjusts the preamble symbol for proceeding analysis in accordance with a cover sequence. The delay unit receives a preamble symbol of a baseband and delayed the preamble symbol. The delay unit 221 receives the preamble symbol and delays the preamble symbol, wherein the delay unit 221 corresponds to a first piconet and a second piconet to delay three reference clocks of the preamble symbol or the delay unit 221 corresponds a third piconet to a seventh piconet to delay one reference clock of the preamble symbol in accordance with the preamble symbol received from the frequency offset estimation circuit of the receiving device.

The multiplier 222 multiplies the preamble symbol and after delayed the preamble symbol by the delay unit 221 for producing a first data. The angle estimator 223 estimates the first data for an estimative value of phase shift. The compensation unit 224 determines the estimative value of phase shift to compensate the estimative value of phase shift, wherein the compensation unit 224 determined the estimative value of phase shift in accordance with a first threshold value. The compensation unit 224 compensates a first compensation value on the estimative value of phase shift when the estimative value of phase shift is grater than the first threshold value even if the compensation unit 224 adds −π on the estimative value of phase shift to revise the cover sequence when the estimative value of phase shift estimated by the angle estimator 223 is grater than

$$\frac{π}{2} ;$$

the same, the compensation unit 224 adds π on the estimative value of phase shift when the estimative value of phase shift estimated by the angle estimator 223 is smaller than

$$- \frac{π}{2} .$$

### The arithmetic logic unit 225 produces a frequency deviation in accordance with after compensated the estimative value of phase shift.

Based on the above assumptions, the frequency offset estimation circuit of the receiving device receives a baseband with a preamble symbol of a cover sequence, which receives m preamble symbol representation in mathematics:

rₘ=αCₘp exp{j2πΔfₘNTₛ}+nₘ

wherein α indicates the attenuation of the wireless transmission channel, Cₘ indicates m cover sequence, Δfₘ indicates m frequency offset, N indicates the length of the preamble sequence in the preamble symbol, Tₛ indicates sampling period, nₘ indicates AWGN noise, P indicates the preamble symbol with frequency offset, the representation is

P=[p₀p₁e^{j2πΔfT}_{^{s}}p₂e^{j2πΔf2T}_{^{s}} . . . p_{N-1}e^{j2πΔf(N-1)T}_{^{s}}]^{T}

wherein pₙ indicates m preamble sequence of the preamble symbol.

The delay unit 221 delays the preamble symbol to obtain m+D preamble symbol and the multiplier 222 multiplies the preamble symbol and m+D preamble symbol to produce a first data, the representation is

$${y}_{m} = {r}_{m}^{H} {r}_{m + D} = {e}^{j 2 πΔ {fDNT}_{s}} ( {C}_{m}^{*} {C}_{m + D} ) {\vert α \vert}^{2} {\sum }_{n = 0}^{N - 1} {\vert {P}_{n} \vert}^{2} + {\tilde{n}}_{m}$$

wherein D indicates that the delay unit 221 delays one reference clock or three reference clocks, accordingly D=1 or D=3. The angle estimator 223 estimates the first data for an estimative value of phase shift, as shown:
while D=1

θₘ=∠{yₘ}=2πΔfNT_{S}+∠(C*ₘCₘ₊₁);

while D=3

θₘ=∠{yₘ}=2πΔf3NT_{S}+∠(C*ₘCₘ₊₃).

### Multiplying the preamble symbol and the cover sequence cause offset of phase π, and therefore 2πΔfNT_{S} and 2πΔf3NT_{S} both are phase offsets by a shaker (not show in picture).

In the Ultra-Wideband Systems of Multi-Band Orthogonal Frequency Division Multiplexing, defining maximum frequency offset of single machine Δf=20 ppm, so the maximum frequency offset Δf=40 ppm between the sending device and the receiving device. The maximum center frequency is 4.488 GHz in the first band to the third band, thus the maximum frequency offset:

Δfₘ|ₘₐₓ=±40*4.488 GHz=±179.52 KHz

wherein when sampling rate of system is 528 MHz and number of sequence of preamble symbol is 165 it calculates the phase deflection is ±2πΔfNT_{S}=±0.1122π or ±2πΔf3NT_{S}=±0.3366π.

By the above mentioned the phase deflection does not exceed

$$\pm \frac{π}{2}$$

caused by the shaker, so when the estimative value of phase shift is grater than

$$\frac{π}{2}$$

the compensation unit 224 adds −π on the estimative value of phase shift, namely \hat{θ}ₘ=θₘ−π; or when the estimative value of phase shift is smaller than

$$- \frac{π}{2}$$

the compensation unit 224 adds π on the estimative value of phase shift, namely \hat{θ}ₘ=θₘ+π. Finally, the arithmetic logic unit 225 produces a frequency deviation in accordance with after compensated the estimative value of phase shift.

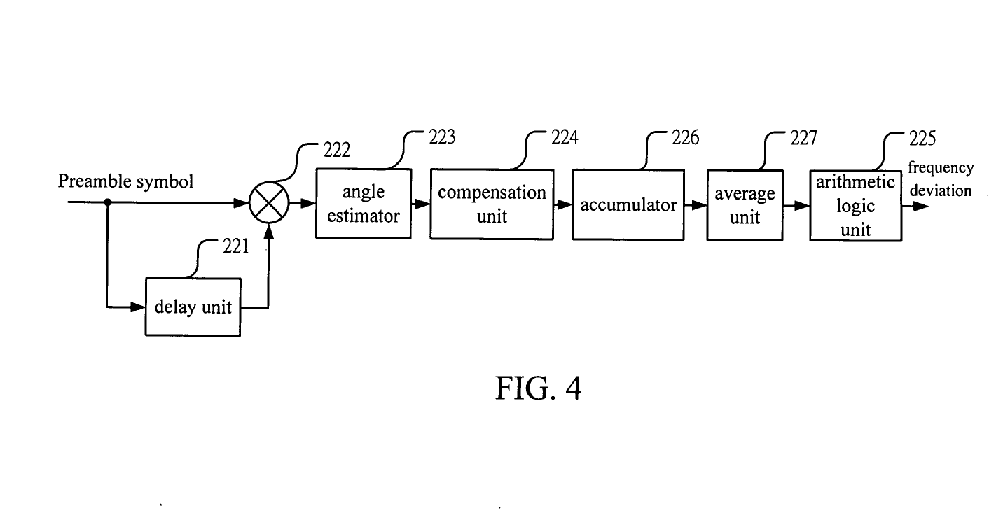

Referring to FIG. 4, it is a block diagram in accordance with another preferred embodiment of the present invention. As drawn, it differs from FIG. 3 in adding an accumulator 226 and an average unit 227. The accumulator 226 accumulates after compensated a plurality of estimative value of phase shift by the compensation unit 224 for producing a total. The average unit 227 averages the total and the total is delivered to the arithmetic logic unit 225 to gain the frequency deviation, namely and accumulates the plural estimative value of phase shift of the preamble symbol for obtaining an average value, this can decrease effect caused by an ambient noise and then gaining average profit efficiency and most accurate estimative value of phase shift, which can obtain from the following formula:

$$\hat{θ} = \frac{1}{M} {\sum }_{m = 0}^{M - 1} {\hat{θ}}_{m} \approx \{ 2 πΔ {fNT}_{s} \} or \{ 2 πΔ f 3 {NT}_{s} \}$$

Finally the arithmetic logic unit 225 is preceding normalization calculation to obtain the frequency deviation, as following:

$$Δ \hat{f} = \frac{\hat{θ}}{2 π {NT}_{s}} or \frac{\hat{θ}}{2 π3 {NT}_{s}}$$

wherein the arithmetic logic unit 225 is a normalization unit, the frequency deviation obtains from the estimative value of normalization phase shift.

The sum up, the frequency offset estimation circuit of the present invention further comprises the delay unit, the multiplier, the angle estimator, the compensation unit, and the arithmetic logic unit. The angle estimator receives that the multiplier multiplies the preamble symbol and after delayed the preamble symbol for producing the first data and estimates the first data for obtaining the estimative value of phase shift. The compensation unit determines the estimative value of phase shift to compensate the estimative value of phase shift. The arithmetic logic unit obtains the correct frequency deviation in accordance with after compensated the estimative value of phase shift.

While the invention has been described with reference to an illustrative embodiment, the description is not intended to be construed in a limiting sense. Various modifications of the illustrative embodiment, as well as other embodiments of the invention, will be apparent to those persons skilled in the art upon reference to this description. It is therefore contemplated that the appended claims will cover any such modifications or embodiments as may fall within the scope of the invention defined by the following claims and their equivalents.

What is claimed is:

1. A frequency offset estimation circuit of receiving device of wireless transmission system, comprising:
a delay unit, received a preamble symbol of a baseband and delayed the preamble symbol, said preamble symbol adjusted by a launcher of said wireless transmission system, said launcher adjusted said preamble symbol in accordance with a cover sequence;
a multiplier, multiplied said preamble symbol and after delayed said preamble symbol by said delay unit for producing a first data;
an angle estimator, estimated said first data for an estimative value of phase shift;
a compensation unit, determined said estimative value of phase shift to compensate said estimative value of phase shift; and
an arithmetic logic unit, produced a frequency deviation in accordance with after compensated said estimative value of phase shift by said compensation unit.

2. The frequency offset estimation circuit as claimed in claim 1, further comprising:
an accumulator, accumulated after compensated a plurality of estimative value of phase shift by said compensation unit for producing a total; and
an average unit, averaged said total and said total is delivered to said arithmetic logic unit to gain the frequency deviation.

3. The frequency offset estimation circuit as claimed in claim 1, wherein said arithmetic logic unit is a normalization unit which normalized said phase shift; said estimative value gained said frequency deviation.

4. The frequency offset estimation circuit as claimed in claim 1, wherein said delay unit corresponded to a first piconet and a second piconet to delay three reference clocks of said preamble symbol.

5. The frequency offset estimation circuit as claimed in claim 1, wherein said delay unit corresponded a third piconet to a seventh piconet to delay one reference clock of said preamble symbol.

6. The frequency offset estimation circuit as claimed in claim 1, wherein said compensation unit determined said estimative value of phase shift in accordance with a first threshold value; said compensation unit compensated a first compensation value on said estimative value of phase shift when said estimative value of phase shift is grater than said first threshold value.

7. The frequency offset estimation circuit as claimed in claim 6, wherein said first threshold value is π/2, said first compensation value is −π.

8. The frequency offset estimation circuit as claimed in claim 6, wherein said first threshold value related to said wireless transmission system applying to under 5 GHz band, a sampling rate of said wireless transmission system is less than 528 MHz and a number of sequence of said preamble symbol is less than 165.

9. The frequency offset estimation circuit as claimed in claim 1, wherein said compensation unit determined said estimative value of phase shift in accordance with a second threshold value; said compensation unit compensated a second compensation value on said estimative value of phase shift when said estimative value of phase shift is less than said second threshold value.

10. The frequency offset estimation circuit as claimed in claim 9, wherein said second threshold value is −π/2, said second compensation value is π.

11. The frequency offset estimation circuit as claimed in claim 9, wherein said second threshold value related to said wireless transmission system applying to under 5 Hz band, a sampling rate of said wireless transmission system is less than 528 MHz and a number of sequence of said preamble symbol is less than 165.

12. The frequency offset estimation circuit as claimed in claim 1, wherein a RF receiving circuit of said receiving device received a Radio Frequency (RF) launched from a launching device of said wireless transmission system in accordance with a Frequency Hop Sequence and converted said Radio Frequency for producing said baseband.

13. The frequency offset estimation circuit as claimed in claim 1, wherein said frequency offset estimation circuit applied to a Multi-Band Orthogonal Frequency Division Multiplexing Ultra Wide Band system.
